(19) United States
(12) Patent Application Publication
(10) Pub. No.: US 2003/0041710 A1
(43) Pub. Date: Mar. 6, 2003

(54) Cutting system

(75) Inventor: Michael D. Kokosh, Champlin, MN (US)

Correspondence Address: Honeywell International Inc., Law Dept. AB2, 101 Columbia Road, P.O. Box 2245, Morristown, NJ, 07962, US

(73) Assignee: Honeywell Advanced Circuits, Inc.

(21) Appl. No.: 09/948,243

(22) Filed: Sep. 6, 2001

(51) Int. Cl. B26D 3/02; B26D 7/06

(52) U.S. Cl. 83/13; 83/432; 83/929.1; 83/435.11

(57) ABSTRACT

A cutting system which reduces the risk of damage to a printed wiring board during bevel formation by using a modified cutter having reduced length cutting edges joined to guide surfaces wherein the cutting edges have an actual angle of intersection which is less than the apparent angle of intersection of the guide surfaces.

### FIELD OF THE INVENTION

The field of the invention is printed wiring board edge shaping systems.

### BACKGROUND OF THE INVENTION

Edge connectors are often used on printed wiring boards to allow the board to be inserted into a socket on another printed wiring board (“PWB”). It is preferable that the leading edge (the edge which is inserted first and extends farthest into the socket) of the edge connector portion of the PWB be beveled to facilitate insertion of the edge connector into the socket. Formation of the beveled edge often entails cutting away the corners of a “rectangular” board by grabbing or clamping the board and moving the board so the edge to be beveled travels between two angled cutting blades that remove the corners of the board. Unfortunately, it is not uncommon for damage to the board to occur during formation of the beveled edge, either during the cutting process itself, or while positioning the board in a cutting system to be used to do the cutting. Thus, there is an ongoing need for improved methods and devices for forming beveled edges that eliminate or reduce the risk of damage to the board during formation of the beveled edge.

### SUMMARY OF THE INVENTION

The present invention is directed to a cutting system which reduces the risk of damage to a printed wiring board during bevel formation by reducing the length of the cutting edges, adjusting the position of the points at which the cutting edges join any non-cutting surfaces, and “dulling” any such points. In particular, a cutting system comprising a clamping mechanism and a cutting mechanism is described wherein the cutting mechanism comprises two cutting edges forming a “V” shape (opposing, non-parallel, and positioned so as to simultaneously contact opposite sides of a work piece), and each of the two cutting edges is coupled at an angle which is greater than 90° and less than 180° to a guide surface; and the “height” of the transition corners where the cutting edges join the guide surfaces above the actual or apparent point of intersection of the cutting edges is less than or equal to 0.15 inches.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a front view of a prior art cutting system having a work piece inserted into it.

FIG. 2 is a front view of a cutting system embodying the invention having a work piece inserted into it.

FIG. 3A is a first detail view of the cutting surfaces, guide surfaces, and transition points of the cutter of FIG. 2.

FIG. 3B is a second detail view of the cutting surfaces, guide surfaces, and transition points of the cutter of FIG. 2.

FIG. 4 is a side view of the cutting system and work piece of FIG. 2.

FIG. 5 is a perspective view of a work piece prior to beveling.

FIG. 6 is a perspective view of the work piece of FIG. 5 after beveling.

### DETAILED DESCRIPTION

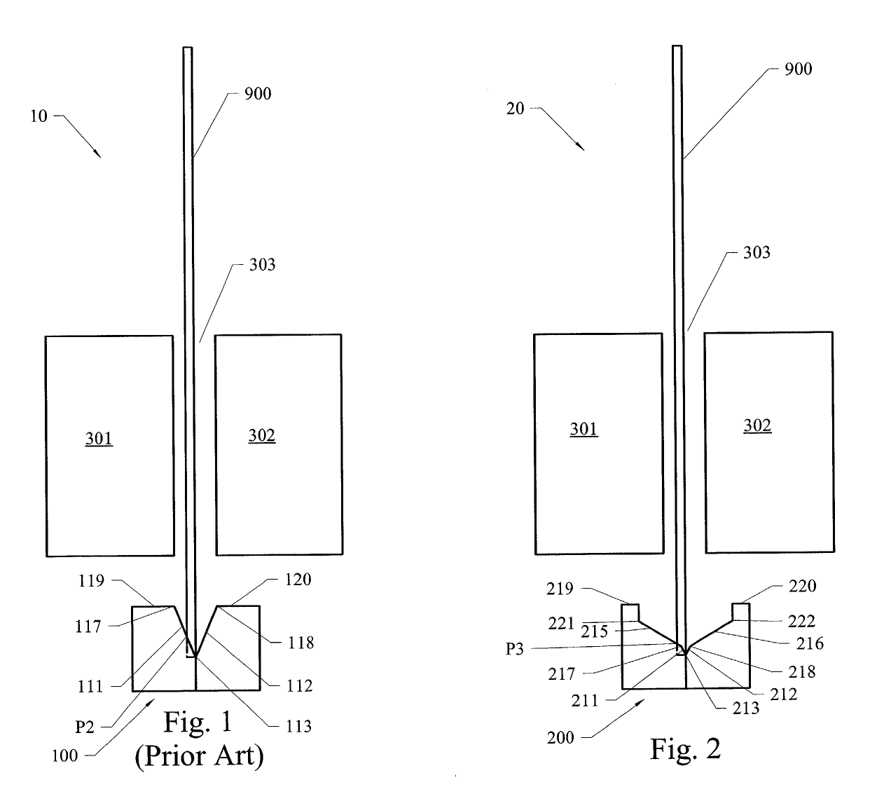

In prior art FIG. 1 it can be seen that prior art cutting system 10 comprises a cutting mechanism that includes cutter 100 and clamping surfaces 301 and 302. Cutter 100 comprises cutting edges 111 and 112 that form a “V” shape having an angle of intersection at vertex 113. Cutting edges 111 and 112 transition into non-cutting edges/surfaces 119 and 120 at transition points 117 and 118. As shown in the figure, a work piece positioned to one side of the gap between clamping surfaces 301 and 302 may potentially contact a cutting edge at a point P2 well above where the bevel cut will be made on the board once it is centered and passed through the cutter.

In FIG. 2, a modified cutting system 20 comprises a modified cutter 200. In cutter 200, cutting edges 211 and 212 have been shortened in length and “relieved” by bending the surfaces of which they are a part so that cutting edges 211 and 212 transition into relieved guide surfaces 215 and 216 respectively at transition points 217 and 218. As used herein, the surfaces are “relieved” because they have an apparent angle of intersection that is greater than the angle of intersection of cutting edges 211 and 212. As shown in the figure, a work piece positioned to one side of the gap between clamping surfaces 301 and 302 may potentially contact a cutting edge at a contact point P3 above where the bevel cut will be made on the board once it is centered and passed through the cutter, but the contact point will be substantially closer to the edge of the work piece than for the prior art cutter.

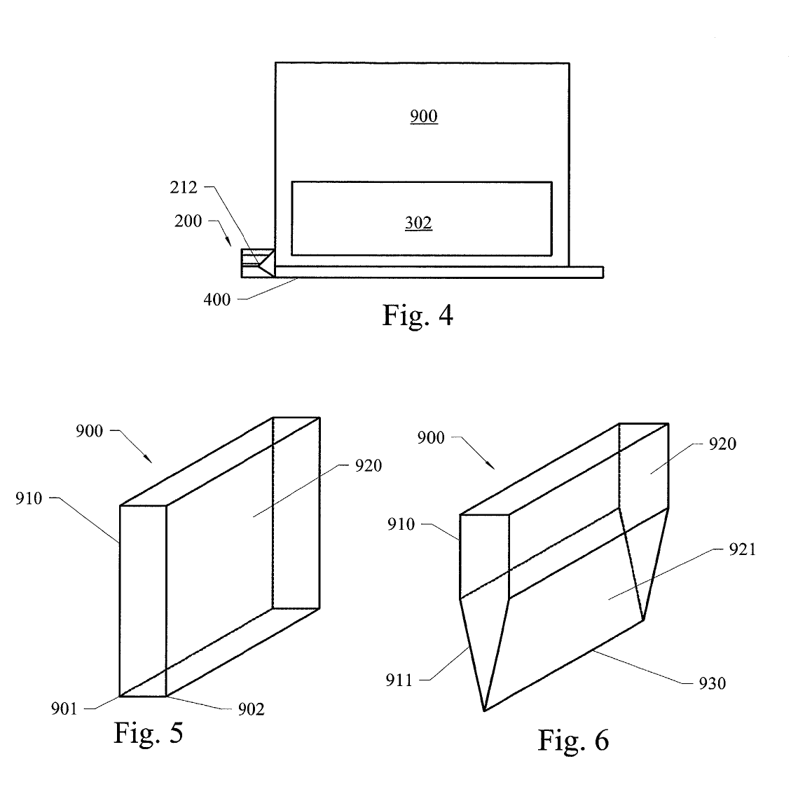

In FIGS. 4-6, a method of using cutting system 20 is partially illustrated by showing the positioning of a printed work piece having the shape of a rectangular plate in the system just prior to clamping and beginning cutting operations, as well as before and after views of the work piece. For simplicity, the work piece will be referred to a printed wiring board (“PWB”) throughout this disclosure. It should be readily apparent, however, that the devices and methods disclosed herein may facilitate modifying edges on work pieces that have different shapes, compositions, or purposes than printed wiring boards.

A typical method of using system 20 is to insert a PWB 900 into the system such that PWB 900 abuts cutter 200 while resting on guide rail 400. During initial insertion, clamping surfaces 301 and 302 are in an open, unclamped position with the width of gap 303 (the distance between surfaces 301 and 302) being significantly greater than the width of the PWB 900. As can be seen in FIG. 2, the gap 303 between clamping surfaces 301 and 302 allows movement of the work piece. Once the PWB is positioned on guide rail 400 and between surfaces 301 and 302, the distance between surfaces 301 and 302 is decreased to cause the surfaces to clamp, or exert pressure on, PWB 900 to hold it in place. PWB 900 is then moved (as are clamping surfaces 301 and 302 as well) relative to cutter 200 to cause cutter 200 to bevel the edge of PWB 900 by removing the two opposing corners 901 and 902 (see FIG. 6) of surfaces 910 and 920. Removal of corners 901 and 902 forms the edge of the PWB into a shape similar to that of FIG. 6. In FIG. 6, the modified/beveled edge comprises bevel surfaces 911 and 921 that are joined at edge 930. If the beveled edge is part of an edge connector, edge 930 will be the leading edge as the connector is inserted into a socket.

It is important that the portions of surfaces 910 and 920 which are not removed during the beveling operation and which are not immediately adjacent to the bevel surfaces 911 and 912 not be damaged during the beveling operation (any references to protecting surfaces 910 and 920 hereinafter should be read as protecting such portions of surfaces 910 and 920). Unfortunately, it has been found that such damage may easily occur during insertion of a PWB into known cutting systems. Although the PWB 900 is intended to abut the cutter 200 before beveling operations begin, it is not uncommon for the PWB 900 to be initially inserted in a manner such that an edge is positioned between cutting edges 211 and 212, and for the PWB to contact upper portions of edges 211 and 212 (as shown in FIG. 1) or one of the transition points 217 and 218. Such contact may result in damage to surfaces 910 and 920. Damaging contact between PWB 900 and cutter 200 may be the result of poor cutting system design or of wear of clamping surfaces 301 and 302.

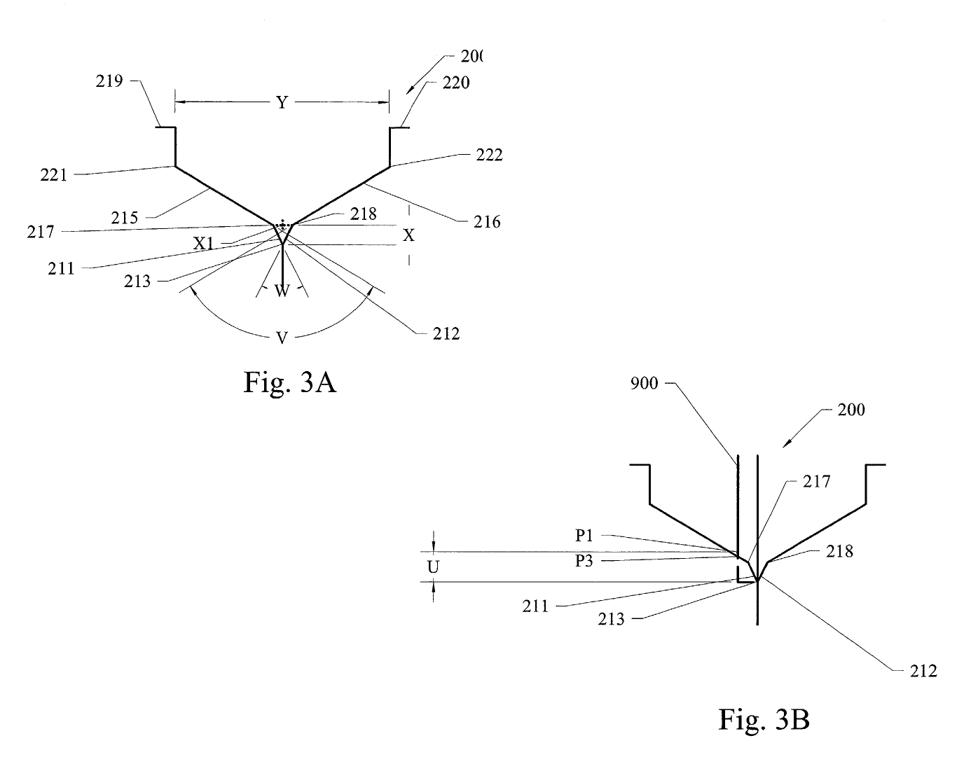

Modified cutter 200 (referring back to FIGS. 2, 3A and 3B), however, helps minimize the risk of damage to surfaces 910 and 920 as cutter 200 provides for a larger distance between transition points 221 and 222, a smaller distance between transition points 217 and 218, shortens the length of cutting edges 211 and 212, positions transition points 217 and 218 closer to the apex of cutting edges 211 and 212, and provides guide surfaces 215 and 216. It should be noted that transition points 217 and 218 are not as sharp as points 117 and 118 of cutter 100, and that guide surfaces 215 and 216 need not be sharp as they are not cutting edges. It should also be noted that, although guide surfaces 215 and 216 should not be needed if the PWB 900 is inserted properly, if PWB 900 extends between guide surfaces 215 and 216 during insertion that those surfaces will aid in positioning PWB 900 on guide rail 400. In some embodiments guide surfaces 215 and 216 may actually be edges formed by the intersection of two or more surfaces.

Although it is preferred that cutting edges 211 and 212 are coupled together at an actual angle of intersection to form a “V” shape, they need not be coupled together, i.e. they may only have an apparent angle of intersection rather than an actual angle of intersection. In such an embodiment edge 930 will be more of a flat surface than sharp edge. It is currently preferred that cutting edges 211 and 212 have an actual angle of intersection W degrees where W is 20 degrees (depending on manufacturing tolerances this actual angle of intersection may not be exactly 20 degrees but will fall between 19 and 21 degrees). Similarly, it is preferred that guides surfaces 215 and 216 have an apparent angle of intersection of approximately V degrees where V is 120 (or between 119 and 121 degrees). Making the apparent angle of intersection of guide surfaces 215 and 216 less than the actual angle of intersection of cutting edges 211 and 212 “dulls” or “softens” transition points 217 and 218.

It is also preferred that the length of cutting edges 211 and 212 be reduced so that the distance between a center point X1 of a line segment extending between transition points 217 and 218 and the vertex 213 of the actual angle of intersection of the cutting edges is less than or equal to X inches where X is one of 0.15, 0.12, 0.1, and 0.8. Similarly, it is preferred that the size of the guide surfaces be adjusted so that the distance between transition points 221 and 222 is at least Y inches where Y is one of 0.35, 0.48, and 0.40. Reducing the length of the cutting edges and adding guide surfaces is contemplated to minimize the risk of a cutting edge improperly contacting surfaces 910 and 920.

In many embodiments cutter 200 will be part of a cutting mechanism 100 of system 10 and clamping surfaces 301 and 302 will be part of a clamping mechanism. In preferred embodiments cutting mechanism 100 will comprise two “blades” (each of which incorporates a cutting edge and a guide surface) welded to a common support member. It is also preferred that clamping mechanism be pneumatically actuated and that surfaces 301 and 302 comprise a material that will yield sufficiently on contact with surfaces 910 and 920 so as not to damage then while providing sufficient pressure on them to hold PWB 900 in place during cutting operations.

It is contemplated that prevention of damage to 910 and 920 will be facilitated by causing the cutter, clamping mechanism and guide rail to operate together to ensure that no portion of surfaces 910 and 920 located more than U inches from an edge of the work piece (such as the portion above point P1 in FIG. 3B) can contact the cutter where U is preferably one of 0.09, 0.1, and 0.11.

Thus, specific embodiments and applications of edge beveling systems have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A system for beveling the edge of a work piece comprising a cutter having two opposing, non parallel cutting edges and two opposing non parallel guide surfaces wherein the cutting edges have an actual or apparent angle of intersection, the guide surfaces have an apparent angle of intersection, and the actual or apparent angle of intersection of the cutting edges is less than the apparent angle of intersection of the guide surfaces.

2. The system of claim 1 wherein each cutting edge is coupled to a guide surface at one of a first pair of transition points, and the distance between a center point of a line segment extending between the first pair of transition points and the vertex of the actual or apparent angle of intersection of the cutting edges is less than or equal to X inches where X is one of 0.15, 0.12, 0.1, and 0.8.

3. The system of claim 2 wherein the maximum distance between a first point on a first of the two guide surface and a second point on a second of the two guide surfaces is at least Y inches where Y is one of 0.35, 0.48, and 0.40.

4. The system of claim 1 wherein the two cutting edges have an actual angle of intersection of W degrees where W is between 19 and 21 degrees.

5. The system of claim 4 wherein the two guide surfaces have an apparent angle of intersection of V degrees where V is between 119 and 121 degrees.

6. The system of claim 1 further comprising a clamping mechanism and a guide rail, the clamping mechanism, guide rail, and cutter operating together to constrain the movement of a work piece inserted into the system such that no portion of a surface of the work piece located more than U inches from an edge of the work piece can contact the cutter where U is one of 0.09, 0.1, and 0.11.

7. A system for beveling the edge of a work piece comprising:
a cutting mechanism;
a clamping mechanism; and
a guide rail;
wherein the cutting mechanism comprises a cutter having two opposing, non parallel cutting edges and two opposing non parallel guide surfaces wherein the cutting edges have an actual or apparent angle of intersection, the guide surfaces have an apparent angle of intersection, and the actual or apparent angle of intersection of the cutting edges is less than the apparent angle of intersection of the guide surfaces;
wherein each cutting edge is coupled to a guide surface at one of a first pair of transition points, and the distance between a center point of a line segment extending between the first pair of transition points and the vertex of the actual or apparent angle of intersection of the cutting edges is less than or equal to 0.1 inches;
wherein the two cutting edges have an actual angle of between 19 and 21 degrees;
wherein the two guide surfaces have an apparent angle of between 119 and 121 degrees; and
wherein the clamping mechanism, guide rail, and cutter operating together to constrain the movement of a work piece inserted into the system such that no portion of a surface of the work piece located more than 0.11 inches from an edge of the work piece can contact the cutter.

8. A method of beveling the edges of a work piece comprising:
providing a cutting system having clamping surfaces, a guide rail, and a cutter with cutting edges and guide surfaces which are not cutting edges;
inserting a work piece between the clamping surfaces and against one of the guide surfaces;
adjusting the position of the work piece so that it is positioned between the clamping surfaces, on the guide rail, and adjacent to the cutter;
forcing at least a portion of an edge of the work piece between the cutting edges of the cutter.

9. The method of claim 8 wherein the cutting edges have an actual angle of intersection and the guide surfaces have an apparent angle of intersection which is less than the actual angle of intersection of the cutting surfaces.

10. The method of claim 9 further comprising selecting a cutter for the cutting system wherein the selection of the cutter is at least partially based on the position of any cutting edge of the cutter to the work piece when the work piece is positioned against only one of the clamping surfaces.
